(19) United States
(12) Patent Application Publication
(10) Pub. No.: US 2012/0112710 A1
(43) Pub. Date: May 10, 2012

(54) Electric machine to regulate work output rotational speed from infinitely variable transmissions by the creation of electrical energy

(76) Inventor: Ross George Haldeman, Albuquerque, NM (US)

(21) Appl. No.: 12/931,798

(22) Filed: Feb. 8, 2011

Related U.S. Application Data
(60) Provisional application No. 61/456,456, filed on Nov. 5, 2010.

(51) Int. Cl. H02P 9/06

(52) U.S. Cl. 322/40

(57) ABSTRACT

The present application relates to an electric machine to regulate the rotational work output speed from an Infinitely Variable Transmission, hereafter noted as IVT, or a Continuously Variable Transmission, hereafter noted as CVT. This application to regulate the work output rotational speed from an IVT or CVT by creating electrical energy may, for explanatory purposes, apply to mechanical gear boxes where it is possible, while holding the input rotational speed constant, to change the work output rotational speed by changing the rotational speed and/or direction of a second rotating shaft. It may, for explanatory purposes, apply to gear boxes using planetary gear sets where the work output rotational speed can be regulated, while holding the input rotational speed constant, by regulating the rotational speed and/or direction of a ring gear. These descriptions are not to limit the scope of this application, but to provide the reader with a sense of what is intended. Since the most common application relating to this device will result in the generation of electrical energy, this energy may be directed, for example, to power the electric supercharger as in patent application Ser. No. 12/802,348, or, in another example, to supply electrical energy to the electric side of a hybrid type of application, and/or power other engine accessories.

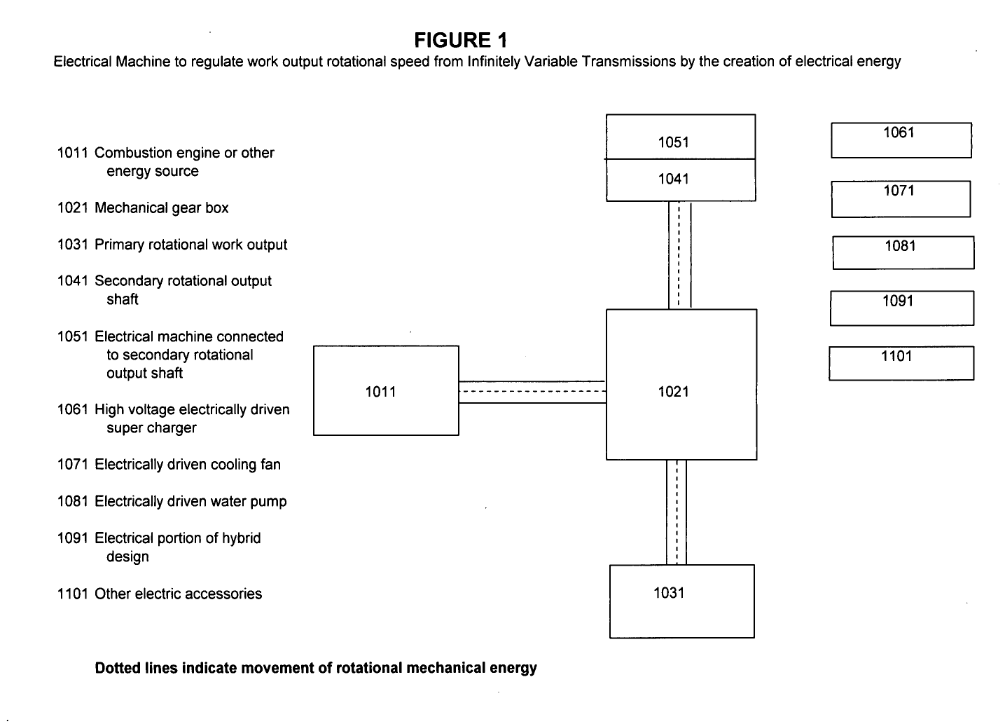

### CROSS REFERENCE TO RELATED APPLICATIONS

THIS APPLICATION CLAIMS THE BENEFIT OF PPA SER. No. 61/456,456, FILED Nov. 5, 2010 BY THE PRESENT INVENTOR, WHICH IS INCORPORATED BY REFERENCE

### BACKGROUND—PRIOR ART

U.S. Patent Documents

| | | | |
|---|---|---|---|
| 01. | 4,583,423 | Apr. 22, 1986 | Hahne |
| 02. | 4,610,184 | Sep. 09, 1986 | Taylor |
| 03. | 6,132,330 | Oct. 17, 2000 | Leggett |
| 04. | 6,338,692 | Jan. 15, 2002 | Magyari |
| 05. | 6,616,564 | Sep. 09, 2003 | Shibukawa |
| 06. | 6,849,023 | Feb. 01, 2005 | Kerr |
| 07. | 6,994,646 | Feb. 07, 2006 | Ai |
| 08. | 7,213,389 | May 08, 2007 | Teijido; et al. |
| 09. | 7,614,973 | Nov. 10, 2009 | Parthuisot; et al. |
| 10. | 20090163319 | Jun. 25, 2009 | Janasek |
| 11. | 20090149296 | Jun. 11, 2009 | Eastman; et al. |
| 12. | 20080269008 | Oct. 30, 2008 | Magyari |
| 13. | 20080269001 | Oct. 30, 2008 | Greenwood; et al. |
| 14. | 20080146414 | Jun. 19, 2008 | Pognant-Gros; et al. |
| 15. | 20080132372 | Jun. 05, 2005 | Baumann |
| 16. | 20070240962 | Oct. 18, 2007 | Parthuisot; et al. |
| 17. | 20060118346 | Jun. 08, 2006 | Rampen; et al. |
| 18. | 20040043856 | Mar. 04, 2004 | Xiaolan |
| 19. | 20040025611 | Feb. 12, 2004 | Naude |

### DISCUSSION OF PRIOR ART

Since the first means of mechanical propulsion came into existence, there has been the need for the ability to change gear ratios between the source of propulsion, hereafter called the engine or energy source, and the final drive mechanism. The less powerful the engine the greater the need to have more gear ratios to select from. In times past, vehicles were able to use large engines to overcome the need for many gear ratios. While this worked from a performance point of view, these large engines rarely worked at their optimum point of operation due to the inability to constantly remain at this optimum point of operation and were thus inefficient.

As fuel prices have sky-rocketed in recent years, there has been high interest, and a serious need, to greatly improve fuel economy. As most companies have resorted to smaller engines, this has created a need for many more gears as these smaller, less powerful engines do not have the torque to pull well at any speed outside of their optimum point of operation, which is too fast for maximum efficiency. Some manufacturers have resorted to transmissions with many gears. But even with a large selection of gearing, these smaller engines are too often out of their optimum point of operation with every gear change. This has brought about a new interest in using transmissions with an infinite number of gear rations to select from.

Some of the earliest transmissions of this type, often referred to as a CVT, use a type of belt drive where one side of the belt pulley on each end of the loop can move in and out, forcing the belt to move closer to or further from the center of the pulley. This movement of the belt placement in the two pulleys is what makes the constantly variable ratios possible. This design can be seen in patent number 01 above. Patent number 15 above refers to a belt rotating around a series of arms that can move in and out, changing the circumference the belt travels on. Again, this will allow for the constantly variable ratios to be possible. Both of these designs depend on a belt for the transmission of large amounts of power. Belts can be quite efficient, but their life is not long and so they will require frequent maintenance. Secondly, both of these designs do not allow for a great range of ratios as their minimum and maximum ratios are limited by the total effective change in pulley diameter.

Other designs such as 04, 05, and 12 above, depend on the bending of metal, either as needles or as a shaft to create different points of contact to create the different ratios. Both of these designs can be plagued by metal fatigue and their range of ratios will be limited by the maximum change afforded within their contact range.

Some designs, such as 07 and 09 above, use a combination of a number of planetary gear sets and multiple electric motors/generators to provide a wider range of gear ratios. These designs will be expensive to build and maintain due to their complexity.

The application in 17 above refers to a simple hydraulic system where a variable displacement hydraulic pump drives a variable displacement hydraulic motor. It is not possible to develop a wide range of ratios from this because the displacement of the variable motor will limit it. This system may also be plagued with heating problems, especially in higher speed applications.

All these, as well as the others I have listed, serve to show the amount of work, variety, and thought that is being put into accomplishing a reliable IVT.

In summary, the force required to move a vehicle using the current fixed gear ratio transmissions is between at least two geared shafts, where the force against one gear being rotated by an external power source is transferred to a second gear that will rotate the work output shaft, which does not want to move because of the load placed against it. In an IVT, there is additional gearing so that the input power may have two possible rotational output pathways. In the first example of this, if the primary work rotational output shaft is connected to the drive mechanism of a machine, this pathway will resist movement due to the work load. This will transfer the power to the secondary rotational output if the input rotational speed remains constant. In the second example, the ring gear of a planetary gear set, being the secondary possible rotational output, will want to spin while the sun gear on the work rotational output shaft remains stopped. In both of these examples, holding the secondary rotational output fixed will result in power being transferred from the input shaft to the primary work output rotational shaft. Allowing the secondary output shaft to rotate freely will result in the primary work output shaft connected to the work not rotating. Some companies using this technology are using hydraulics to control the rotational speed of the secondary output source. However, if they are generating hydraulic power, the need for hydraulic power is not generally very great for the majority of normal operating situations. This application is about using this mostly wasted energy by converting it to electricity to power such things as engine accessories such as an electric cooling fan, electric water pump, electric hydraulic pump, electric supercharger, and/or supplementing the electric power in a hybrid form of propulsion, as well as future vehicle electrical needs.

### DESCRIPTION

### Field of the Invention

The field of the present invention is in the ability to capture the unused energy created, in the form of electricity of 120 volts or higher, when a regulating control is applied to a secondary internal rotating mechanism of an IVT or CVT in order to regulate the rotational speed of the primary work output shaft.

### BACKGROUND OF THE INVENTION

My first understanding of a mechanical, all gear IVT came when I was shown where a company was using what was described to me as a hydraulic motor to control the speed of the ring gear of a planetary gear set to regulate the work output speed of their new IVT. This concept seems to be consistent in the IVT patents I looked at. Most IVTs refer to using a motor connected to a secondary output source to regulate the rotational speed of the primary work output shaft.

Later I learned of a company that brought out a new hybrid version of an existing model that uses a new IVT. This hybrid vehicle has a larger displacement gas engine than the non-hybrid version, and when combined with the electrical portion, produces 23% more horsepower but is only slightly faster in a zero to sixty mph run. I decided to research to see what kind of IVT they were using to learn where this inefficiency existed. I learned they were using a simple brake mechanism to regulate the secondary output rotational speed in their IVT in order to control the work rotational speed. To slow the vehicle, the braking force on the secondary shaft would be reduced, allowing the secondary shaft to spin faster and the rotational work output shaft to turn slower. To increase vehicle speed this process would be reversed. I immediately thought back to the first IVT I saw and realized the term hydraulic motor, which was given to me, was in reality most likely incorrect. For the vast majority of the time it would most likely be a hydraulic pump. I could see that if this pump/motor were replaced with an electrical machine, I would have a source of abundant electrical energy to power the computer-controlled supercharger in my patent application Ser. No. 12/802,348 as well as adding electrical energy to the electric hybrid combination that is so common, and other engine accessories.

As I have pointed out in my patent application Ser. No. 12/802,348, the demand for more fuel-efficient engines for all applications will be great. The electric supercharger will be a more efficient and more easily controlled means of creating boost to a combustion engine. If we get the electrical power to operate it from the energy currently not being used in most IVTs, the increase in efficiency will add considerably to the overall efficiency.

### SUMMARY OF THE INVENTION

In patent application Ser. No. 12/802,348 one of the points I make is the generation of electrical power to drive the electric supercharger will be more efficient then creating rotational energy from air passing over the fan blades of the turbo charger. This point was made with the idea of using a belt-driven high voltage alternator/generator. Now with this current application we can capture energy that is truly being wasted most of the time to power all kinds of electrical accessories. In the case of the first IVT I saw, if the motor shown to me was in reality a hydraulic pump, the machine this IVT was in could use this hydraulic energy only part of the time. Most of the time, the vast majority of this available hydraulic energy would simply be wasted since there would be little use for it.

In the example of the hybrid car mentioned above, not only would this current application do away with the inefficiencies they are showing in their literature due to the losses of using a brake mechanism to restrain rotation inside the transmission, but the electrical power generated could be fed into the electric hybrid portion of this vehicle, making it even more efficient both in performance and in fuel mileage, by replacing power from the gas engine with power from the electric motor. If this 5200-pound hybrid vehicle were using the electrically driven supercharger in application Ser. No. 12/802,348 and the electric machine in this present application, this vehicle would be capable of fuel mileage seriously exceeding the current 23 mpg, with performance exceeding most fast sports cars.

This has been an exciting thought to be able to combine these two inventions together to greatly reduce our dependence on foreign oil while at the same time giving us vehicles with superb performance that weigh enough so they can be built strongly to protect the occupants in case of an accident and to also provide the weight to help hold the vehicle steady on slippery roads and in high wind situations.

### BRIEF DESCRIPTION OF FIGURE ONE

The features and advantages of this application will become apparent to those skilled in the art from the following diagram and detailed description showing how the use of an electrical machine to regulate the rotational speed of the secondary rotational output will in turn regulate the rotational output speed of the primary work output from an Infinitely Variable Transmission.

FIGURE one shows the simplest diagram. It does not, and cannot, show all the many different types of mechanical gearboxes that could be used. In this example drawing, the mechanical gearbox most resembles a differential. I have chosen to use this example simply and only because it makes the concept easier to understand. In reality, this gearbox could contain a planetary gear set or other gear designs. It could contain more than one gear ratio, and/or forward and reverse gearing. Input and output shafts could be in totally different positions. But no matter the design, it must be possible to have two rotational work outputs.

In FIGURE one, the power begins in (1011), the combustion engine or other energy source. This rotational energy transfers to (1021), the mechanical gear box. For this example, the rotational speed entering the mechanical gear box (1021) will remain constant. Inside the gear box, (1021), there will be two possible directions this energy input may be directed. One will be to (1031), the primary rotational work output. The second will be to (1041), the secondary rotational work output. Because (1031) is the primary work output it will resist rotation. If no means of controlling (1041) is used, it will be the only shaft to turn and all energy will be directed to it. The present application uses an electrical machine (1051) attached to this secondary output (1041). If we create an electrical load against the electrical machine (1051), this will cause the electrical machine to restrict the rotation of the secondary output (1041) and transfer the rotational energy to the primary work output source (1031). By increasing the electrical load on the electrical machine (1051), the secondary output (1041) will slow down and cause the primary work output shaft (1031) to speed up. By reducing the electrical load on the electrical machine (1051), the secondary output (1041) will speed up and cause the primary work output (1031) to rotate more slowly. The greater the amount of work being done by the primary work output (1031), the greater the electrical work load that must be applied to the electrical machine (1051) to maintain the desired speed of the primary work output (1031).

Also, the greater the work load against the energy source (1011) coming through the mechanical gear box (1021), the greater the need for electrical power to increase the boost provided by the electric super charger (1061) to the energy source (1011), and/or the greater the demand for electrical power coming from the electrical side of a hybrid design (1091). In the above example, the increased work load being done by the primary work output (1031) will also require more electrical power to operate the electric fan (1071) and the electric water pump (1081) to keep the primary energy source (1011) properly cooled. So as the load increases against the primary work output (1031), a greater electrical load must be created against the electrical machine (1051) in order to restrict the tendency of the secondary output (1041) to speed up, which would allow the primary work output shaft (1031) to slow down or stop. This situation causes the creation of electricity in the electrical machine (1051) in proportion to the demand for it. Through proper gearing and sizing of the electrical machine (1051), there can be enough available electrical energy to power other electrical accessories (1101) in future applications.

The invention claimed is:

1. An electrical machine to regulate the primary work output rotational speed of an IVT, or CVT, gear transmission through control of the rotational speed of the secondary rotational output and capture the energy available in the form of electrical current.

2. The electrical machine in claim 1 may be used to generate electricity to power an electrically powered supercharger.

3. The electric machine in claim 1 may be used to generate electricity to be added to the electrical portion of an electric hybrid vehicle, either directly to the electric motor or to the battery.

4. The electrical machine in claim 1 may be used as a power source to operate counter-rotational to its use in claim 1 to add greater rotational speed range and/or direction to the work output from the IVT or CVT.

5. The electric machine in claim 1 may be used to generate electricity to drive engine accessories, including but not limited to, the water pump, fan, and hydraulic pump, providing variable speed capabilities not tied to engine speed. This will also allow stopping the fan and hydraulic pump altogether when not needed, reducing emissions and fuel consumption.
